(19) United States
(12) Patent Application Publication
(10) Pub. No.: US 2010/0040721 A1
(43) Pub. Date: Feb. 18, 2010

(54) ROLLER PRESS FOR HIGH PRESSURE BRIQUETTING OF BIOMASS, LOW RANK COALS AND OTHER FIBROUS MATERIALS

(76) Inventors: Roman T. DEC, Anniston, AL (US); Richard K. KOMAREK, Itasca, IL (US)

Correspondence Address: LADAS & PARRY LLP, 224 SOUTH MICHIGAN AVENUE, SUITE 1600, CHICAGO, IL, 60604, US

(21) Appl. No.: 12/540,108

(22) Filed: Aug. 12, 2009

Related U.S. Application Data
(60) Provisional application No. 61/088,247, filed on Aug. 12, 2008.

(51) Int. Cl. B28B 13/02

(52) U.S. Cl. 425/237

(57) ABSTRACT

An improved method and apparatus for forming briquettes particularly adapted to low rank coal fines, various biomass waste and other particulate or fibrous materials uses asymmetric mating rollers, having alternating grooves and outer lips, where the outer lips of a first roller contact the groove of a second roller and the outer lips of the second roller contact the groove of the first roller, briquette forming cavities being formed in the outer lips and the rollers travel at rotational velocities that may be either synchronized or slightly mismatched.

### CLAIM OF PRIORITY

This invention claims priority based on U.S. Provisional Application Ser. No. 61/088,247 identified by the title “ROLLER PRESS FOR HIGH PRESSURE BRIQUETTING OF BIOMASS, LOW RANK COALS AND OTHER FIBROUS MATERIALS and the named inventors Roman T. Dec, Anniston, Ala., (USA) and Richard K. Komarek, Itasca, Ill., (USA) filed Aug. 12, 2008.

### BACKGROUND OF THE INVENTION

The invention relates to an improved method and apparatus for forming briquettes particularly adapted to low rank coal fines, various biomass waste and other particulate or fibrous materials

### DESCRIPTION OF RELATED ART

The briquetting industry started about 100 years ago taking fine coal and putting it into usable lumps (i.e. briquettes) which were used for home heating both in Europe and North America.

This prior art briquetting process relied on 8 to 10% asphalt or bitumen to bind the briquettes under low briquetting pressures. After World War II, the use of coal for home heating declined to the point were this process was no longer used in North America and the briquetting industry concentrated on other applications—primarily chemicals, ores, and metal powders.

There are a lot of low rank coal fines, various biomass waste and other particulate fibrous materials which could be turned into easy handleable and durable form by pressing those materials into briquettes if appropriate methods and apparatus can form suitable briquettes. Such briquettes can be utilized in industrial boilers or domestic stoves as an energy source, be a suitable feed for various carbonization devices or for many other processes.

It is difficult to obtain satisfactory quality briquettes from such materials in roll type briquetting machines with traditional pressing systems, consisting of die cavities cut into opposing roll surfaces and a timing mechanism closely matching cavities of both rolls. Because of the significant elasticity of the above mentioned materials, internal residual stresses build up causing failure of previously formed briquette structure. Typically observed damage is separation (splitting) in the centerplane region (also called “clam shelling”) which in the case of fibrous materials is intensified by the layering action of the rolling process.

Presentations and papers on briquetting include R. T. Dec, A. Zavaliangos, R. K. Komarek “Analysis of the Roller Press Forming Cavity Profile Using Finite Element Simulation, 28th Biennial Conference of the Institute for Briquetting and Agglomeration, Sep. 14-17, 2003, Proceedings, Vol. 28, pp. 55-65 and A. Zavaliangos, R. T. Dec, R. K. Komarek, “Analysis of Powder Processing in the Roller Press Using Finite Element Modeling”, Proceedings; XXII International Mineral Processeding Congress, Cape Town, South Africa, Sep. 28-Oct. 3, 2003, Vol. 1, pp. 298-306. These papers explain analytical methods which model certain forces which may affect properties of finished briquettes under prior art roller configurations and the papers are incorporated by reference as if fully set forth herein. The papers are not believed to teach solutions to problematic briquette properties such as splitting or clam shelling.

### SUMMARY OF THE INVENTION

A pressing system design and method of manufacturing briquettes from materials such as low rank coal fines, various biomass and other particulates or fibrous materials that eliminates the structural defects and fractures observed in the prior art is needed.

The briquetting roll set of the invention has a first roll having the working surface shaped as alternating grooves and outer lips, where the outer lips have forming cavities cut and spaced around the circumference. A second mating roll has the working surface shaped similarly to the first roll but being contraposed, resembling the first roll but with its geometry shifted so the groove in the first roll is adjacent to an outer lip of the second roll, next to it axially, while the intermeshing outer lip on the second mating roll is adjacent to the groove of the first roll.

The first and second roll can be positioned for rotation about respective axes and each individual roll can be driven by a separate power feed so the rolls are rotating with the identical or slightly mismatched angular velocity.

The first and second rolls can also be positioned for rotation about their respective axes and only one roll driven by the power feed while the second mating roll freely rotates with the angular velocity imposed by frictional coupling throughout the densified material.

### BRIEF DESCRIPTION OF THE DRAWINGS

FIG. 1 is an isometric view of the roller press designed in accordance with present invention used to produce briquettes from biomass, low rank coal and other fibrous materials.

FIG. 2 is an isometric view of the first and second mating roll.

FIG. 3 is a top elevation view of the first and second mating roll.

FIG. 4 is a cross-sectional view of the first and second mating roll along section line A-A of FIG. 3.

FIG. 5 is a partial cross-sectional view of the first and second mating roll along section line B-B of FIG. 4.

FIG. 6 is an isometric view of the briquette.

### DETAILED DESCRIPTION OF THE PREFERRED EMBODIMENT

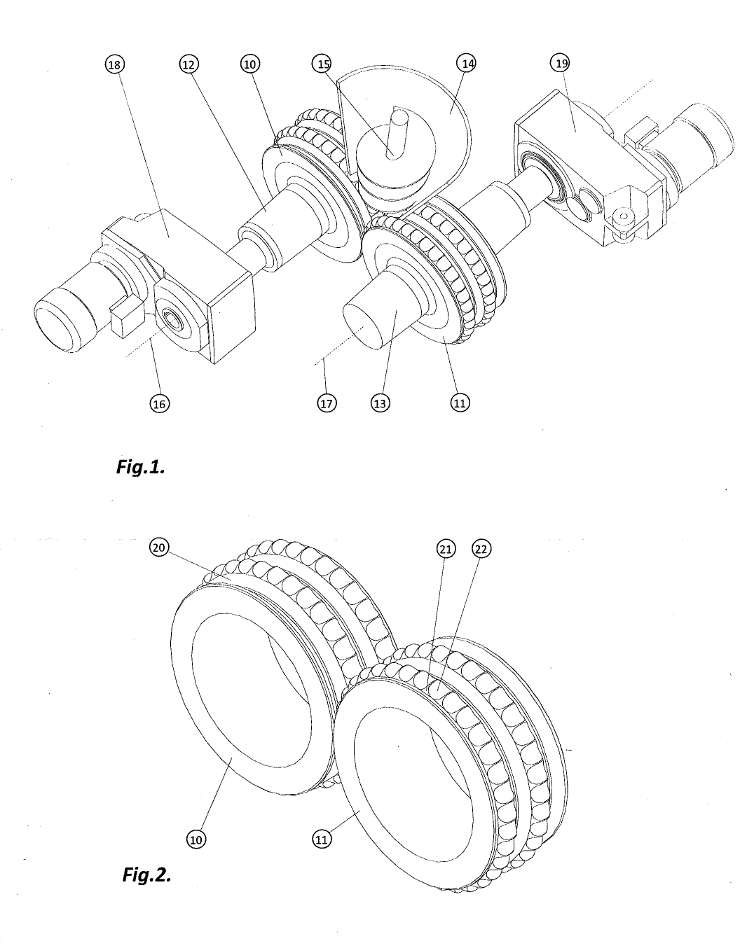

Referring to FIGS. 1 and 2, a first roll 10 and a second roll 11 are mounted on shafts 12 and 13 and placed in a support frame (not shown). Each of the rolls is mounted for rotation about axis 16 and parallel axis 17, respectively. The forming surfaces of the rolls are not symmetrical. The part of the forming surface of one roll is continuous groove 20 coaxial with roll axes 16, and it matches with the forming surface of a counterpart roll in the shape of external lip 21 closely engaged with the groove 20. The axes 16 and 17 are spaced by a distance such that the circumferential surfaces of roll 10 and 11 mate as shown in FIG. 2.

In operation, rolls 10 and 11 can be driven with the same angular velocity but in opposite rotational directions by two separate geared motors 18 and 19. There is no need for position alignment between forming cavities, so rolls can be individually driven which eliminates the necessity of using special synchronizing gear reducer with double shaft output. Angular velocity of the rolls 10 and 11 can be identical or with slight mismatch. Depending on the materials being briquetted, there may be an advantage in operating at either a synchronous or a synchronous angular velocity. Drive arrangement with one roll driven by geared motor and second roll freely rotating with the velocity imposed by frictional coupling throughout the densified material is also possible.

Feed material, preferably in the particulate form, is supplied to the feed hopper 14 and is precompacted and pushed to the roll nip region by cylindrical or conical screw 15.

The respective surfaces of the rolls 10 and 11 are defined by the number of grooves and outing lips intermeshing with each other. Cavities 22 are cut into the outer part of the lip 21. Other suitable methods of forming such as casting, forging or stamping, may be suitable in particular circumstances. Material is formed into a briquette between the cavity 22 acting as a one half of a forming die and the concave surface of the groove 20, which is creating closing half of the die.

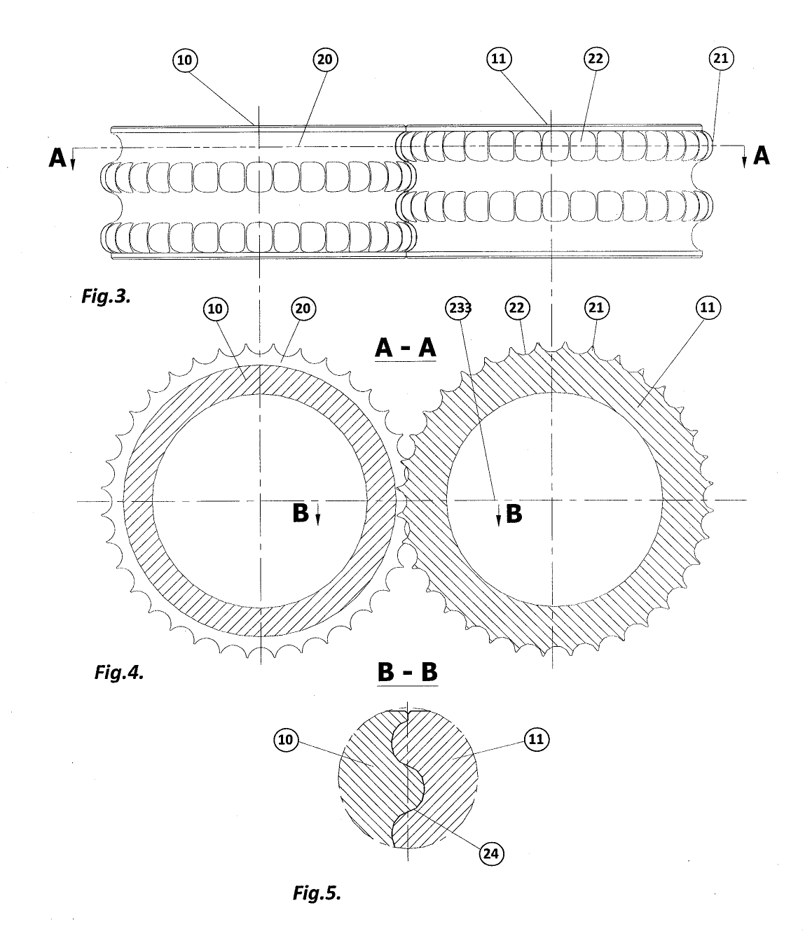

The roll surface design can be described in more detail in conjunction with FIGS. 3, 4 and 5.

An axial cross section of the roll set 10 and 11 illustrates that lip 21 fits tightly to the corresponding grove 20. The clearances are due to manufacturing tolerances and to wear. Curvature 24 of the cross section of the roll external lip and corresponding groove depends on application and is optimized each time based on desired roll diameter and properties of the feed material by the means of finite element modeling. The optimizing procedure determines also geometry of the forming cavities cut into the outer part of the lip. Design is optimized by maximizing briquette density and minimizing the value of destructive residual stresses. While the literature identifies the effects of stresses, it does not specifically teach the present solution.

While four rows of forming dies are shown, one of ordinary skill will understand that other numbers of side by side rows may be employed, limited only by the width of the rolls and general constraints in building roller press suitable for high pressure briquetting. The number of forming cavities cut around roll circumference in each external lip in a preferred embodiment will preferably be 36 to 52.

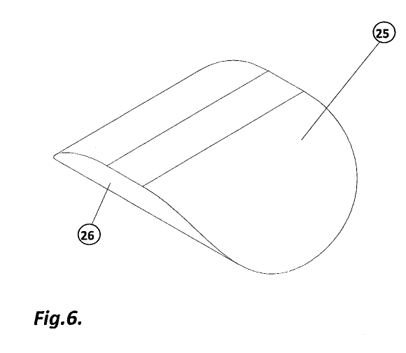

As a result of compaction of the feed material between two rotating rolls 10 and 11 a dense briquette is formed when the center of forming cavity 22 is passing the centerline of the rolls 23 (FIG. 4). The volume the briquette resulting from the roll forming geometry is defined by two intersecting surfaces 25 and 26 (FIG.6.). Surface 25 is a representation of the geometry of forming cavity 22, whereas surface 26 is an image of the concave surface of the groove 20.

Briquettes formed such a way are well compacted, expressing good effective strength throughout entire volume and are free of destructive residual stresses in spite of their significant elastic response. Additional shear stresses imposed to the briquette structure by differences in the forming die surfaces velocity have additional beneficial effect on briquette strength and integrity.

While the preferred embodiment of the invention has been illustrated and described, it will be appreciated that various changes can be made therein without departing from the spirit and scope of the invention.

1. An apparatus for forming briquettes comprising:
a briquetting roll set with a first roll having a first working surface shaped as alternating first grooves and first outer lips, where said first outer lips have first forming cavities cut and spaced around a first circumference;
a second mating roll having a second working surface shaped as alternating second grooves and second outer lips, where said second outer lips have second forming cavities cut and spaced around a second circumference;
said first and second grooves, outer lips, and forming cavities cut are contraposed so that the second grooves, second outer lips, and second forming are geometrically shifted so said first groove is adjacent to a second outer lip, next to it axially and the second outer lip intermeshes said first groove;
said grooves, lips and cavities coacting as forming dies;
said forming dies having each cavity acting as a one half of a forming die and the concave surface of each groove acting as a closing half of the die.;
said first roll and second roll are positioned for rotation about respective first and second axes;
said first axes and second axes are parallel and spaced so that the respective first and second surfaces mate;
said first and second roll are driven by one of a dual drive or a single drive;
said dual drive is formed and arranged so that said first and second roll are driven respectively by a separate first power feed and second power feed so the rolls are rotating at selected angular velocities which may be identical or mismatched angular velocities;
said single drive is formed and arranged so that said first and second rolls are positioned for rotation about their respective first and second axes and said first roll is driven by a first power feed while said second roll freely rotates with the angular velocity imposed by frictional coupling;
said dual drive operates using a first geared motor and a second geared motor and said single drive operates using a first geared motor and a freewheeling second rotational arrangement;
the curvature of the cross section and geometry of the first and second lip, first and second cavities and first and second grooves, based on material properties of the briquette material maximizes briquette density and minimizes destructive residual stresses in the briquettes;
the angular velocity of the first roll and the angular velocity of the second roll, based on material properties of the briquette material maximizes briquette density and minimizes destructive residual stresses in the briquettes.

2. An apparatus for forming briquettes comprising:
a briquetting roll set with a first roll having a first working surface shaped as alternating first grooves and first outer lips, where said first outer lips have first forming cavities cut and spaced around a first circumference;
a second mating roll having a second working surface shaped as alternating second grooves and second outer lips, where said second outer lips have second forming cavities cut and spaced around a second circumference;
said first and second grooves, outer lips, and forming cavities cut are contraposed so that the second grooves, second outer lips, and second forming are geometrically shifted so said first groove is adjacent to a second outer lip, next to it axially and the second outer lip intermeshes said first groove;
said grooves, lips and cavities coacting as forming dies;
said forming dies having intersecting first cavities and second curved surfaces;
said first roll and second roll are positioned for rotation about respective first and second axes;
said first axes and second axes are parallel and spaced so that the respective first and second surfaces mate.

3. The briquette forming apparatus of claim 1, further comprising:
said first and second roll are driven by one of a dual drive or a single drive;
said dual drive is formed and arranged so that said first and second roll are driven respectively by a separate first power feed and second power feed so the rolls are rotating at selected angular velocities which may be identical or mismatched angular velocities;
said single drive is formed and arranged so that said first and second rolls are positioned for rotation about their respective first and second axes and said first roll is driven by a first power feed while said second roll freely rotates with the angular velocity imposed by frictional coupling;
said dual drive operates using a first motor and a second motor and said single drive operates using a first motor and a freewheeling second rotational arrangement.

4. The briquette forming apparatus of claim 3 further comprising:
the angular velocity of the first roll and the angular velocity of the second roll, based on material properties of the briquette material maximizes briquette density and minimizes destructive residual stresses in the briquettes.

5. The briquette forming apparatus of claim 1, further comprising:
the curvature of the cross section and geometry of the first and second cavities and second and first grooves, based on material properties of the briquette material maximizes briquette density and minimizes destructive residual stresses in the briquettes.

6. The briquette forming apparatus of claim 4, further comprising:
the curvature of the cross section and geometry of the first and second cavities and second and first grooves, based on material properties of the briquette material maximizes briquette density and minimizes destructive residual stresses in the briquettes.

7. An improved apparatus for forming briquettes particularly adapted to low rank coal fines, various biomass waste and other particulate or fibrous materials comprising:
first and second asymmetric mating rollers;
said first and second rollers having alternating first and second grooves and first and second outer lips;
said first outer lips contact said second groove;
said second outer lips contact said first groove;
first and second briquette forming cavities are formed by said first and second outer lips;
said first and second rollers rotate around first and second axes at first and second rotational velocities respectively;
said first and second rotational velocities are one of synchronized velocities or slightly mismatched velocities.

8. The briquette forming apparatus of claim 7, further comprising:
said first and second grooves, outer lips, and forming cavities cut are contraposed so that the second grooves, second outer lips, and second forming are geometrically shifted so said first groove is adjacent to a second outer lip, next to it axially and the second outer lip intermeshes said first groove;
said grooves, lips and cavities coacting as forming dies;

9. The briquette forming apparatus of claim 8, further comprising:
said forming dies having intersecting first cavities and second curved surfaces;
said first roll and second roll are positioned for rotation about respective first and second axes.

10. The briquette forming apparatus of claim 9, further comprising:
said first axes and second axes are parallel and spaced so that the respective first and second surfaces mate.

11. The briquette forming apparatus of claim 10, further comprising:
said first and second roll are driven by one of a dual drive;
said dual drive is formed and arranged so that said first and second roll are driven respectively by a separate first power feed and second power feed so the rolls are rotating at selected angular velocities which may be identical or mismatched angular velocities;
said dual drive operates using a first geared motor and a second geared motor.

12. The briquette forming apparatus of claim 10, further comprising:
said first and second roll are driven by a single drive;
said single drive is formed and arranged so that said first and second rolls are positioned for rotation about their respective first and second axes and said first roll is driven by a first power feed while said second roll freely rotates with the angular velocity imposed by frictional coupling;
said single drive operates using a first geared motor and a freewheeling second rotational arrangement.

13. The briquette forming apparatus of claim 10, further comprising:
the curvature of the cross section and geometry of the first and second lip, first and second cavities and second and first grooves, based on material properties of the briquette material maximizes briquette density and minimizes destructive residual stresses in the briquettes.

14. The briquette forming apparatus of claim 13, further comprising: the angular velocity of the first roll and the angular velocity of the second roll, based on material properties of the briquette material maximizes briquette density and minimizes destructive residual stresses in the briquettes.
